(19) United States
(12) Patent Application Publication
(10) Pub. No.: US 2009/0035596 A1
(43) Pub. Date: Feb. 5, 2009

(54) OPTICAL FILM AND METHOD FOR PRODUCING THE SAME

(75) Inventor: Souichiro Higashi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, Tokyo (JP)

(21) Appl. No.: 12/162,280

(22) PCT Filed: Jan. 23, 2007
(86) PCT No.: PCT/JP2007/051333

§ 371 Date: Jul. 25, 2008

(30) Foreign Application Priority Data
Jan. 27, 2006 (JP) 2006-019559

(51) Int. Cl. B29D 11/00; B29C 55/12; G02B 1/04

(52) U.S. Cl. 428/480; 264/2.6

(57) ABSTRACT

It is an object of the present invention to provide an optical film having low heat shrinkage and a method for producing the same. A heat treatment (60) carrying a biaxially stretched film of a thermoplastic resin (12′) prepared by biaxial stretching in a heated atmosphere is conducted, and/or a heat treatment (70) carrying the biaxially stretched film while bringing the biaxially stretched film into contact with a heating roller (72) is conducted.

### TECHNICAL FIELD

The present invention relates to an optical film, and a method for producing the same. Particularly, the present invention relates to an optical film which is excellent in heat dimensional stability and has very low heat shrinkage (hereinafter, referred to as low heat shrinkage), and a method for producing the same.

### BACKGROUND ART

A thermoplastic resin film is produced by a melt film forming method. In the melt film forming method, a thermoplastic resin is melted in an extruder, and then extruded on a support, for example, a cooling drum from a die to form a thermoplastic resin film. The thermoplastic resin film formed by this method is usually biaxially stretched in a long (longitudinal) direction and in a wide (transverse) direction.

By the way, the molecules of a biaxially stretched thermoplastic resin film are orientated by the stretching to enhance mechanical properties such as strength. However, since the distortion caused by the stretching remains in molecule chains conversely, the distortion of the molecules chains is released by applying heat, and thereby the film is shrunk (hereinafter, this character is referred to as heat shrinkage). Generally, this heat shrinkage becomes an obstacle in many cases when particularly using the film as optical uses. Then, the distortion of the molecule chains are released by transversely stretching and succeedingly heat treatment (heat fixation) in a tenter used for transversely stretching in the case of the biaxially stretching (for example, Japanese Patent Application Laid-Open No. 8-132523). Japanese Patent Application Laid-Open No. 2000-310830 discloses that the heat shrinkage (heat dimensional change) of a thermoplastic resin film is reduced by controlling the water contents of a film and coating liquid in applying the coating liquid onto the thermoplastic resin film.

### DISCLOSURE OF THE INVENTION

However, although the amount of the heat shrinkage is reduced according to the temperature of the heat treatment in Japanese Patent Application Laid-Open No. 8-132523, the distortion cannot be completely removed, and unfortunately the heat shrinkage remains. When the coating liquid is a water system also in Japanese Patent Application Laid-Open No. 2000-310830, the distortion cannot be removed. Also, the low heat shrinkage required for the optical film required for low heat shrinkage has not been obtained.

The present invention has been accomplished in view of the foregoing circumstances. It is an object of the present invention to provide an optical film having low heat shrinkage and a method for producing the same.

The foregoing and other objects are accomplished, according to a first aspect of the present invention, by providing a method for producing an optical film comprising: conducting a heat treatment comprising carrying a biaxially stretched thermoplastic resin film prepared by biaxial stretching in a heated atmosphere, and/or conducting a heat treatment comprising carrying the biaxially stretched film while bringing the biaxially stretched film into contact with a heating roller.

The inventor of the present has extensively studied based on the aforementioned problems, and, as a result, they have found that the heat shrinkage of the film can be particularly reduced by conducting the heat treatment comprising carrying the thermoplastic resin sheet prepared by biaxial stretching in the heated atmosphere, and/or conducting the heat treatment comprising carrying the sheet while bringing the sheet into contact with the heating roller.

Therefore, according to the present invention, the heat shrinkage of the film can be reduced by the heat treatment by carrying the film in the heated atmosphere and/or the heat treatment by carrying the film while bringing the film into contact with the heating roller.

According to a second aspect of the present invention, there is provided a method for producing the optical film as set forth in the first aspect of the present invention, wherein the heat treatment is conducted in a state where a coating layer is formed on the biaxially stretched film.

This is because the optical film having lower heat shrinkage can be produced by forming the coating layer on the biaxially stretched film and by conducting the heat treatment of the biaxially stretched film with the coating layer.

According to a third aspect of the present invention, there is provided a method for producing the optical film as set forth in the second aspect of the present invention, wherein the heat treatment comprising carrying the biaxially stretched film in the heated atmosphere also functions as a drying step for the coating layer.

Since the heat treatment comprising carrying the biaxially stretched film in the heated atmosphere according to the present invention also functions as the drying step for the coating layer, the heat shrinkage of the film can be also efficiently suppressed while a solvent contained in the coating layer can be dried.

According to a fourth aspect of the present invention, there is provided a method for producing the optical film as set forth in any one of the first to third aspects of the present invention, wherein the heat treatment is conducted after 3 to 20% heat relaxation of the biaxially stretched film is conducted in a transverse direction.

According to the fourth aspect of the present invention, the optical film having lower heat shrinkage can be prepared by previously conducting 3 to 20% heat relaxation of the film in the transverse direction in a transverse stretching step or the like before the heat treatment. The heat relaxation in the transverse direction is preferably 3 to 20%, and more preferably 7 to 10%.

According to a fifth aspect of the present invention, there is provided a method for producing the optical film as set forth in any one of the first to fourth aspects of the present invention, wherein the biaxially stretched film carried in the heated atmosphere has a tension of 30 to 150 N/m and the atmosphere has a temperature of 130 to 180° C.

According to the fifth aspect of the present invention, the heat shrinkage of the optical film can be effectively reduced by conducting the heat treatment comprising carrying the optical film in the heated atmosphere in these ranges. Lower tension for carrying is preferable, and a tensionless state is ideal. However, the tension must be in a range where the optical film can be relaxed in the MD direction without loosened while the film is carried. There is no problem when the tension is 30 to 150 N/m. An excessive low atmosphere temperature for the heat treatment cannot relax the tension, and an excessive high atmosphere temperature melts the film. Thereby, the atmosphere temperature is preferably 130 to 180° C.

According to a sixth aspect of the present invention, there is provided a method for producing the optical film as set forth in any one of the first to fifth aspects of the present invention, wherein the biaxially stretched film carried while being brought into contact with the heating roller has a tension of 80 to 450 N/m and the roller has a temperature of 145 to 160° C.

According to the sixth aspect of the present invention, the heat shrinkage of the optical film can be effectively reduced and the flatness can be enhanced by conducting the heat treatment comprising carrying the film while bringing the film into contact with the heating roller in these ranges by an iron effect on the heating roller. The tension for carrying must be in a range where the film can be carried while the film is brought into contact with the heating roller without loosened film while the film is carried, and there is no problem when the tension is 80 to 450 N/m. An excessive low atmosphere temperature for the heat treatment cannot relax the tension, and an excessive high atmosphere temperature melts the film. Thereby, the atmosphere temperature is preferably 145 to 160° C.

According to a seventh aspect of the present invention, there is provided a method for producing the optical film as set forth in any one of the first to sixth aspects of the present invention, wherein the biaxially stretched film after the heat treatment has heat shrinkage of 0.5% or less in a machine direction (MD direction) and heat shrinkage of 0.1% or less in a transverse direction (TD direction).

Referring to the optical film produced by the method for producing of the present invention, the heat shrinkage in the machine direction (MD direction) can be set to 0.5% or less and the heat shrinkage in the transverse direction (TD direction) can be set to 0.1% or less.

According to an eighth aspect of the present invention, there is provided an optical film prepared by the method for producing of the optical film according to any one of the first to seventh aspects.

Since the optical film produced by the present invention has low heat shrinkage, the optical film can be preferably used for optical uses.

According to a ninth aspect of the present invention, there is provided an optical film as set forth in the eighth aspect of the present invention, wherein the thermoplastic resin is a polyester resin.

The present invention can further exhibit the effect of the present invention when the thermoplastic resin is the polyester resin.

According to a tenth to seventeenth aspects of the present invention, there is provided a light diffusion sheet, electromagnetic wave shielding sheet, infrared ray shielding sheet, UV shielding sheet, hard coat sheet, anti-glare sheet, prism sheet or antireflective sheet comprising the optical film as set forth in the eighth or ninth aspect of the present invention.

Since various functional sheets using the optical sheet of the present invention as a substrate have low heat shrinkage, the sheets excel in dimensional stability and can be preferably used as optical members without changing optical characteristics.

According to the present invention, the optical film having low heat shrinkage can be produced. Therefore, the quality of members such as an antireflective film which uses the optical film produced by the present invention can be enhanced.

### BRIEF DESCRIPTION OF THE DRAWINGS

FIG. 1 is a constitution diagram of a film producing apparatus according to the present invention;

FIG. 2 schematically illustrates the constitution of a heat treatment A step part;

FIG. 3 schematically illustrates the constitution of a heat treatment B step part;

FIGS. 4A to 4D illustrate another embodiment of the present invention; and

FIG. 5 schematically illustrates another constitution of the heat treatment A step part.

### DESCRIPTION OF SYMBOLS

10: film producing apparatus, 12: polyester film, 12′: stretched polyester film, 12″: stretched polyester film after heat treatment (optical film), 20: film forming step (part), 22: extruder, 24: die, 28: (casting) drum, 30: longitudinal stretching step (part), 40: transverse stretching step (part), 50, 50′: coating step (part), 60, 60′: heat treatment A step (part) (drying step (part)), 70: heat treatment B step (part), 71: furnace, 72: roller, 74: nip roll, 76: tension measuring roll, 80: winding step (part)

### BEST MODE FOR CARRYING OUT THE INVENTION

Hereinafter, preferred embodiments of the optical film and method for producing the same according to the present invention will be described with reference to the accompanying drawings.

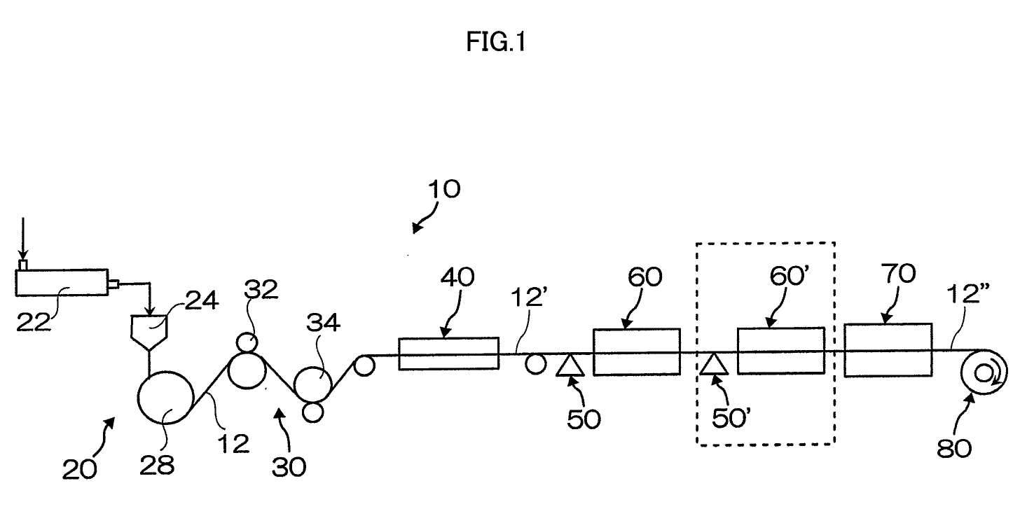

FIG. 1 shows an example of a constitution diagram of an optical film producing apparatus of the present invention. A resin of the optical film of the present invention needs only to be a thermoplastic resin capable of being formed as a film and having various high functionalities such as mechanical properties, thermal properties and electrical properties. A polyester resin will be described in the embodiment.

As shown in FIG. 1, a producing apparatus 10 is mainly configured by a film forming step part 20 for forming a polyester film 12 before stretching, a longitudinal stretching step part 30 and a transverse stretching step part 40 for respectively longitudinally stretching and transversely stretching the polyester film 12 formed in the film forming step part 20, an easy adhesive coating step part 50 for coating an undercoating layer (easy adhesive layer) onto the stretched polyester film 12′, a heat treatment A step part 60 for drying the coated undercoating layer, a heat treatment B step part 70 for conducting a heat treatment of the stretched film having the produced undercoating layer by roll carrying, and a winding step part 80 for winding up a low heat shrinkage polyester film (optical film) 12″ produced by conducting the heat treatment.

In the film forming step part 20, the melted polyester resin is extruded in a sheet form from a die 24 by an extruder 22, and is cast on a rotating drum 28. The melted resin is cooled and solidified on the surface of the drum 28 to obtain the polyester film 12. After the polyester film 12 is peeled off from the drum 28, the polyester film 12 is sequentially carried to the longitudinal stretching step part 30 and the transverse stretching step part 40 where the polyester film 12 is stretched to produce the stretched polyester film 12′. After the undercoating layer is coated in the easy adhesive coating step part 50, and the heat treatment is conducted in the heat treatment A step part 60 and the heat treatment B step part 70, the stretched polyester film 12′ is wound in a roll shape in the winding step part 80. Thereby, a low heat shrinkage polyester film (optical film) is produced.

Hereinafter, a method for producing the low heat shrinkage polyester film will be described in detail as the method for producing the optical film of the present invention.

Polyester forming a low heat shrinkage polyester support is composed of a dicarboxylic acid and a diol. Preferable examples of the dicarboxylic acids include terephthalic acid, naphthalenedicarboxylic acid, isophthalic acid, orthophthalic acid, paraphenylene dicarboxylic acid, and an ester former thereof. The diol is preferably ethylene glycol, butylene glycol, cyclohexanedimethanol, neopentyl glycol, bisphenol A and biphenol. Even if hydroxycarboxylic acid is used except the diol and the dicarboxylic acid, the polyester can be formed, and parahydroxybenzoic acid and 6-hydroxy-2-naphthalene carboxylic acid may be used. The content of the terephthalic acid or naphthalenedicarboxylic acid contained in the total dicarboxylic acid units is preferably 50 mol % to 100 mol % for attaining such polyester. This may be a copolymer or a polymer blend. Of these, polyethylene terephthalate (PET) and polyethylene naphthalate (PEN) are particularly preferable.

After dicarboxylic acid and dialcohol as raw materials are reacted under pressure of 1 to 2 kg/mm² or under the atmospheric pressure at 180 to 280° C. for 0.5 to 8 hours for ester exchange, the polyester can be obtained by heating and polymerizing under a vacuum of 50 to 1 mmHg at 240 to 290° C. for 1 to 3 hours. At this time, it is preferable to add the raw materials in a slurry state. That is, the fine particles of the dicarboxylic acid or a diester thereof and terephthalic acid are formed, and the fine particles are dispersed in ethylene glycol to be supplied as the slurry. An ester exchange reaction catalyst or a polymerization reaction catalyst may be used if needed at the time of the polymerization thereof, or a heat resistant stabilizer (for example, phosphorous acid, phosphoric acid, trimethylphosphate, triethylphosphate, tetraethylammonium) may be added. These polyester synthetic methods can be conducted by referring to, for example, Kobunshi Jikkengaku, Vol. 5, “Polycondensation and Polyaddition” (Kyoritsu Shuppan, 1980), p 103 to 136, “Synthetic Polymer V” (Asakura Publishing Co., Ltd., 1971), p 187 to 286, and Japanese Patent Application Laid-Open Nos. 5-163337, 3-179052, 2-3420, 1-275628, 62-290722 and 61-241316 or the like.

It is preferable that these polyesters have a glass transition temperature (Tg) of 50° C. or more, more preferably 60° C. or more, and still more preferably 65° C. or more in view of heat resistant. It is preferable that the polymer thus polymerized has an ultimate viscosity of 0.40 to 0.9, measured at 35° C. in an orthochlorophenol solvent. It is more preferable that the polymer has an ultimate viscosity of 0.45 to 0.70. Easily sliding properties can be also applied to the polyester film according to the present invention by the kneading of an inactive inorganic compound used as the general technique. Examples of the inactive inorganic particles include SiO₂, TiO₂, BaSO₄, CaCO₃, talc and kaolin. Both a method for applying the easily sliding properties due to an external particle system for adding inactive particles to a polyester composition reaction system and a method for applying easily sliding properties due to an internal particle system for depositing a catalyst or the like added in the polymerization reaction of the polyester are employable. Preferable amount to be added is 5 ppm to 1000 ppm, more preferably 10 ppm to 500 ppm. The size of the particle to be added is preferably 0.01 μm to 10 μm, and more preferably 0.05 μm to 5 μm.

Then, a method for forming the polyester film will be described. The polymer polymerized by the above method is pelletized, and the pelletized polymer is dried at 80° C. to 200° C. for 1 hour or more. This pellet is melted at no less than the melting point temperature (Tm) of the polymer and no more than 330° C. by the extruder 22 of the film forming step part 20. It is preferable that the melted polymer is then previously filtered using a filter (not shown). Examples of the filters include metal wire, sintered metal wire, sintered metal, sand and glass fiber. The melted resin is continuously supplied to the die 24 of FIG. 1. The supplied melted resin is discharged in a sheet form from the tip (lower end) of the die 24. After the discharged melted resin is cast on the casting drum 28 and cooled and solidified on the surface of the drum 28, the resultant film is peeled off from the surface of the drum 28 to form the polyester film 12. The melted polymer extruded from the die 24 is extruded on the casting drum 28 set to Tg-80° C. to Tg (Tg: glass transition temperature of polyester), and more preferably Tg-60° C. to Tg-10° C. At this time, it is also preferable to improve the adhesion with the drum by an electrostatic applying method or a liquid film forming method (fluid such as water is coated on the casting drum and the adhesion of the melted polymer and drum is improved) to improve the flatness.

The polyester film 12 formed in the film forming step part 20 is sequentially carried to the longitudinal stretching step part 30 and the transverse stretching step part 40. Hereinafter, the polyester film 12 produced in the film forming step part 20 is stretched, and the stretching step until the stretched polyester film 12′ is produced will be described.

As shown in FIG. 1, the polyester film 12 is first longitudinally stretched in the machine direction in the longitudinal stretching step part 30. After the polyester film 12 is preheated in the longitudinal stretching step part 30, the polyester film 12 is wound around two nip rolls 32 and 34 with the polyester film 12 heated. The nip roll 34 of the outlet side carries the polyester film 12 at the carrying speed faster than that of the nip roll 32 of the inlet side, and thereby the polyester film 12 is stretched in the longitudinal direction.

The polyester film 12 longitudinally stretched is carried to the transverse stretching step part 40 where the polyester film 12 is transversely stretched in the transverse direction. For example, a tenter can be preferably used in the transverse stretching step part 40. Both end parts of the polyester film 12 in the transverse direction are grasped by a clip using the tenter to stretch the polyester film 12 in the transverse direction (lateral direction). The film is preferably stretched by a factor of 3.0 to 4.0 at a temperature of Tg+20° C. to 55° C. in the transverse direction. The tension of the film is then relaxed in the transverse direction at Tg+60° C. to 100° C. At this time, the distortion of the transversely stretching is relaxed and the dimensional change in the TD direction (transverse direction) is reduced by conducting 3 to 20% relaxation, preferably 7 to 10% relaxation in the transverse direction.

Referring to the stretched polyester film 12′ thus obtained, the undercoating layer (easy adhesive layer) is provided in the easy adhesive coating step part 50. Herein, there are a so-called multilayer method for providing a layer (hereinafter, abbreviated as undercoating first layer) having good adhesion to the film 12′ as a first layer and for coating a layer (hereinafter, abbreviated as undercoating second layer) having good adhesion to a resin coated in a different step from the undercoating first layer as a second layer thereon, and a single layer method for coating only one layer. In the case of the single layer method, the easy adhesive coating step part 50′ and drying step part 60′ of FIG. 1 are unnecessary.

In the undercoating first layer in the multilayer method, for example, there are used a copolymer using a monomer selected from vinyl chloride, vinylidene chloride, butadiene, vinyl acetate, styrene, acrylonitrile, methacrylate ester, methacrylic acid, acrylic acid, itaconic acid, anhydrous maleic acid or the like as a starting material, an epoxy resin, gelatin, nitrocellulose and polyvinyl acetate or the like. There may be added crosslinking agents such as a triazine system, an epoxy system, a melamine system, an isocyanate system containing a block isocyanate, an aziridine system and an oxazarin system, inorganic particles made of colloidal silica or the like, a surfactant, a thickener, dye, an antiseptic agent or the like if needed. The resin or the like used for the first layer is also similarly used even in the undercoating second layer.

In the single layer method, there are used many methods for swelling a support and causing interfacial mixture with an undercoating polymer to provide good adhesiveness. As the undercoating polymer, there are used gelatin, a gelatin derivative, casein, agar, alginic acid soda, starch, polyvinyl alcohol, a water-soluble polymer such as a polyacrylic acid copolymer and an maleic anhydride copolymer, a cellulose ester such as carboxymethyl cellulose and hydroxyethyl cellulose, a latex polymer such as a vinyl chloride-containing copolymer, a vinylidene chloride-containing copolymer, an acrylic ester-containing copolymer, a vinyl acetate-containing copolymer, and a vinyl acetate-containing copolymer.

The thickness of the first layer is preferably 10 to 500 nm, and more preferably 30 to 150 nm. The film thickness of less than 10 nm causes inadequate adhesiveness with the stretched polyester film 12′, and the film thickness exceeding 500 nm causes the worsened state of the surface.

The method for coating the first layer is not particularly limited, and there can be used known methods such as a bar coater coating and a slide coater coating. As the coated solvent, there can be also used water, toluene, methyl alcohol, isopropyl alcohol and methyl ethyl ketone, and a water system and organic solvent system coated solvents of a mixed system thereof or the like. Of these, the method for using water as the coated solvent is preferable in view of the cost and the simplicity of manufacture.

Although the thickness of the second layer is not also particularly limited, the thickness is 10 to 5000 nm, and more preferably 20 to 1500 nm. The film thickness of less than 10 nm causes inadequate adhesiveness with the upper layer, and the film thickness exceeding 5000 nm causes the worsened state of the surface.

The method for coating the second layer is not also particularly limited, and known methods such as the bar coater coating and the slide coater coating can be used. Also, the second layer may be coated by the same method as that of the first layer, and may be coated by a different method. Furthermore, the second layer may be coated simultaneously with the first layer and dried, and as shown in FIG. 1, the second layer may be coated after coating and drying the first layer.

As the coated solvent for coating the second layer, there can be also used water, toluene, methyl alcohol, isopropyl alcohol and methyl ethyl ketone, and a water system and organic solvent system coated solvents of a mixed system thereof or the like. The coated solvent may be also the same as that of the first layer, and may be different. As the coated solvent of the second layer, the method for using water is also preferable in view of the cost and the simplicity of manufacture.

Thus, the heat treatment A of the stretched polyester film on which the undercoating layer is coated is conducted by drying the solvent of the undercoating liquid and by carrying the film in the heated atmosphere in the heat treatment A step part 60 (60′).

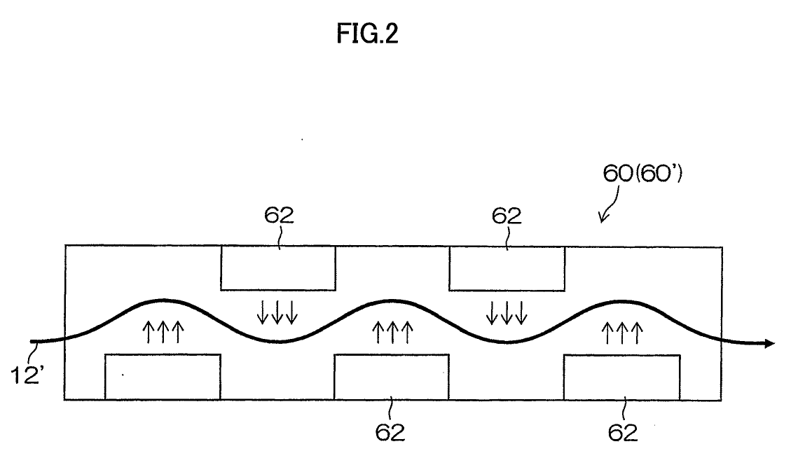

As the heat treatment A step part 60, a drier of a parallel non-contact drying system can be preferably used. As shown in FIG. 2, in the drier of the parallel non-contact drying system, air headers 62 which blow off drying wind are alternately provided along with the carrying line of the stretched polyester film 12′ at both the upper part and lower part sandwiching the stretched polyester film 12′ on which the undercoating layer is coated in the drying step part 60. The drying wind is blown off toward the film 12′ from the air headers 62. Thereby, the film 12′ travels in a noncontact state so that a sine curve is drawn in the drying step part 60, and the coated film is dried.

Thus, when the heat treatment of the film 12′ is conducted in the heat treatment A step part 60 carrying the film 12′ while surfacing the film 12′ by hot wind in the heated atmosphere, the heat shrinkage of the film 12′ in the machine direction (MD direction) can be reduced. In that case, the heat treatment temperature is 130° C. to 190° C., and preferably 150° C. to 180° C. The tension is 30 to 150 N/m, and preferably 50 to 100 N/m. Even if such heat treatment can provide the same effect in carrying in a single heat treatment zone and a plurality of heat treatment zones. It is preferable that a remaining heat zone and a slow cooling zone are respectively provided at the inlet and outlet of the heat treatment zone in order to improve the flatness. Thereby, base deformation of a tinplate shape generated when the optical film 12″ is largely expanded and constricted by a sharp temperature change can be suppressed.

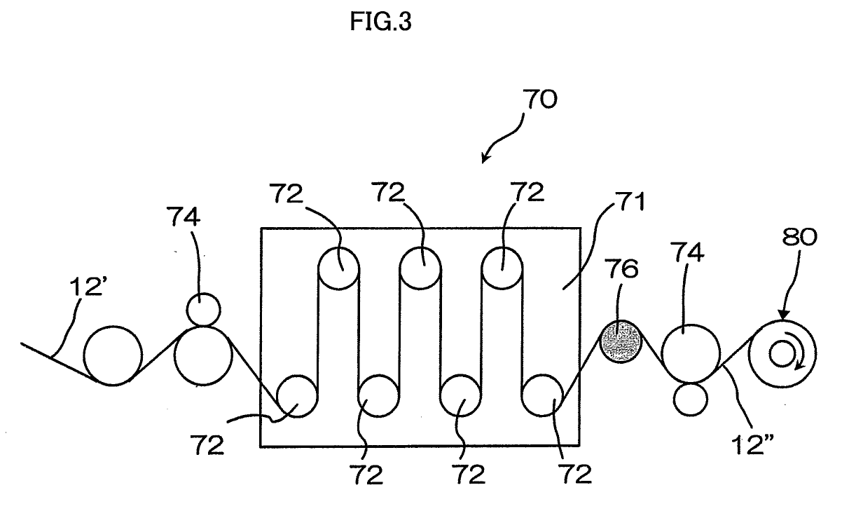

Then, the heat treatment B step part 70 according to the present invention will be described. FIG. 3 shows an example of the constitution of a heat treatment B apparatus 70 used for the present invention. Since the heat treatment of the stretched polyester film 12′ stretched in the longitudinal stretching step 30 and the transverse stretching step 40 is conducted in the heat treatment B step part 70 as shown in FIG. 1, the heat treatment of the stretched polyester film 12′ may be conducted after the transverse stretching step 40 and before the winding step part 80. The heat treatment of the stretched polyester film 12′ once wound in the winding step part 80 after longitudinal and transverse stretchings may be conducted by carrying the film 12′ to an apparatus composed only of the heat treatment step.

In the heat treatment B apparatus 70, the inside of a furnace 71 for adjusting temperature is provided with rollers 72, 72 . . . for carrying the stretched polyester film 12′. Therefore, the rollers 72, 72 . . . are heated at the same temperature as that of the inside of the furnace 71. A nip roll 74 for carrying the stretched polyester film 12′ to the furnace 71 and for drawing out from the furnace 71 is preferably used in order to carry the film 12′ while maintaining the low tension of the film 12′. Thereby, the low tension can be maintained by measuring the tension by a tension measuring roll 76 and by changing the revolving speed of the roller of the nip roll 74. In this case, a suction drum may be used in place of the nip roll 74 in order to conduct a tension cut. The heat treatment B apparatus 70 may raise the temperature of the stretched polyester film 12′ using heat transmission obtained by contacting the film 12′ with a hot heat carrier such as the heat roller. Although any method may be used, it is preferable to reduce the temperature distribution in the transverse direction in order to reduce the distribution of the heat shrinkage in the transverse direction.

Thus, the heat shrinkage can be further reduced and the high flatness can be obtained by carrying the stretched polyester film 12′ while bringing the film 12′ into contact with a plurality of rollers 72 in the heated atmosphere, or by carrying the film 12′ while bringing the film 12′ into contact with the heat roller. In that case, it is preferable that the temperature of the roller is 145 to 160° C. and the tension is 80 to 450 N/m. Defects such as the local dent and ruffle of the stretched polyester film 12′ can be reduced by the iron effect on the rollers 72, 72 . . . , thereby improving the flatness.

The optical film having the heat shrinkage of 0.5% or less in the machine direction (MD direction) and the heat shrinkage of 0.1% or less in the transverse direction (TD direction) can be formed by the above method for producing the optical film.

The heat shrinkage in the machine direction (MD) and the heat shrinkage in the transverse direction (TD) can be calculated by JIS C-2318.

Heat shrinkage(%)=100×(L1−L2)/L2

L1: Distance (mm) between Reference Points before Heating, L2: Distance (mm) between Reference Points after Heating

As described above, the embodiment of the method for producing the optical film according to the present invention was described. However, the present invention is not limited to the above embodiment, and various kinds of aspects can be employed.

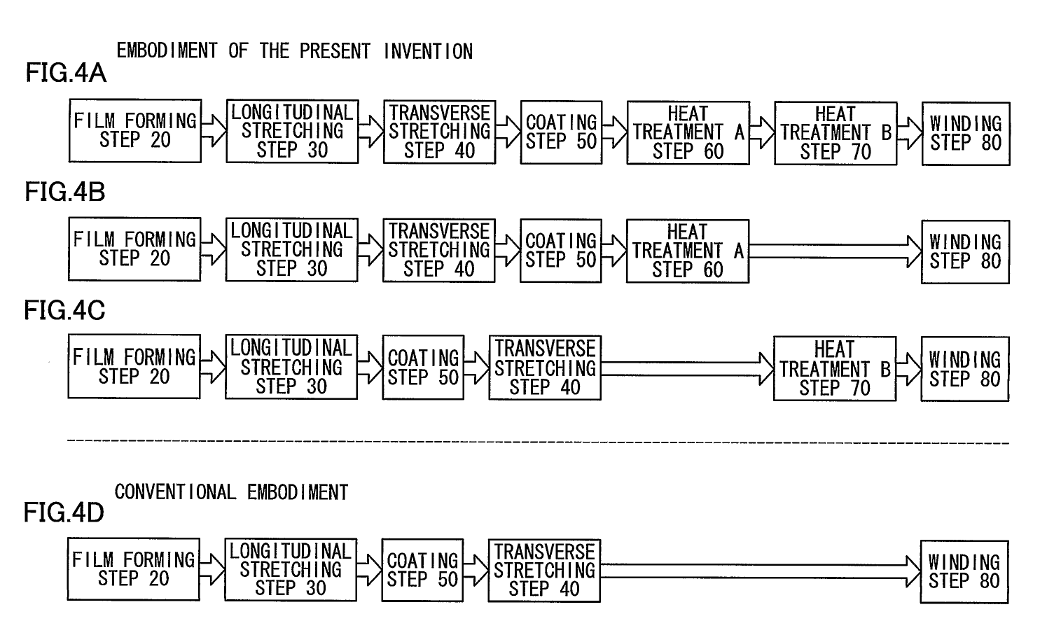

Although, for example, FIG. 4A shows the embodiment of FIG. 1, as shown in FIG. 4B, the case where only the heat treatment A step 60 is conducted without conducting the heat treatment B step 70 is also contained in the present invention. In this case, the heat shrinkage in the machine direction (MD direction) can be reduced. It is preferable that the remaining heat zone and the slow cooling zone are respectively provided at the inlet and outlet of the heat treatment zone in order to improve the flatness in the same manner as in the embodiment of FIG. 1. Thereby, base deformation of a tinplate shape generated when the optical film 12″ is largely expanded and constricted by a sharp temperature change can be suppressed.

As shown in FIG. 4C, the present invention also contains the case of conducting the coating step 50 before the transverse stretching step 40 in the same manner as in the conventional method (see FIG. 4D), drying the coating liquid coated in the coating step 50 in the transverse stretching step 40 and then conducting the heat treatment B step 70. Even in this case, the heat shrinkage of the optical film 12″ can be reduced, and the high flatness can be obtained.

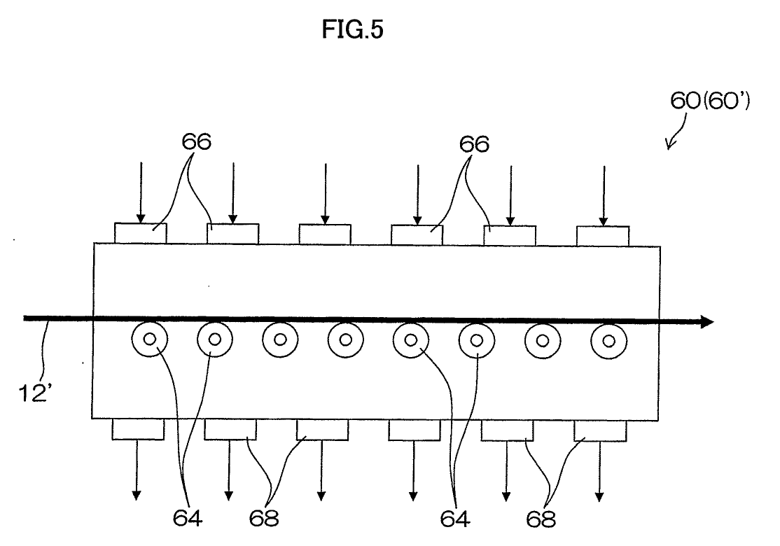

Although the case of using the drier of the parallel non-contact drying system in the heat treatment A step part 60 (60′) was described, the same effect is obtained also when a drier of a roller carrying drying system generally used is used. As shown in FIG. 5, in the drier of the roller carrying drying system, a plurality of pass rollers 64, 64 . . . are provided along with the transverse traveling line of the film 12′ and the opposite side of the coated film of the film 12′ is supported by the pass rollers 64. Air blown off into the drier from a plurality of drying wind supplying ports 66, 66 . . . and drying the coating layer is exhausted from a plurality of exhaust ports 68, 68 . . . , and the coated film is dried.

Although the case of providing the easy adhesive layer on one surface of the film 12′ was described in the embodiment, the case of providing the easy adhesive layers on both the surfaces is also the same. The present invention is not limited to a case of coating the easy adhesive layer in the coating step 50, and for example, the present invention also contains a case where the optical film is produced by coating a backcoat layer for blocking prevention or the like and an antistatic layer for prevention of electrification.

Referring to the optical film of the present invention, it is preferable to combine functional layers described in detail in pages 32 to 45 or the like in disclosure technical report of Japan Institute of Invention and Innovation (disclosure technical number 2001-1745, Mar. 15, 2001 issue, Japan Institute of Invention and Innovation). Of these, an optical diffusion layer (light diffusion sheet), an electromagnetic wave shield layer (electromagnetic wave shielding sheet), an antireflective layer (antireflective sheet) and a hard coat layer (hard coat sheet) or the like are particularly preferably applied. Since the optical sheet which is the substrate has excellent dimensional stability, the functional sheet having excellent optical characteristics can be obtained.

### EXAMPLES

Hereinafter, the present invention will be described in further details with reference to Examples. However, the present invention is not limited thereto.

### <Biaxially Stretched Film>

A polyethylene terephthalate (hereinafter, described as PET) resin having an intrinsic viscosity of 0.66 was produced by polycondensation using Ge as a catalyst. The PET was dried so that the water content was set to 50 ppm or less, and was melted in an extruder of which the heater temperature was set to 280 to 300° C. The melted PET resin was discharged on a chill roll electrostatically applied from a die part to obtain an amorphous base. After the obtained amorphous base was stretched by 3.3 times in the base travelling direction, the amorphous base was stretched by 3.8 times in the transverse direction to obtain a biaxially stretched film (optical film) having a thickness of 100 or 175 μm.

### [Experiment 1]

### <Heat Treatment Step>

The above PET base having a thickness of 100 or 175 μm was carried at a carrying speed of 105 m/min. A film which was not subjected to a heat treatment (described as A step in Table 1) by carrying the PET base in the heated atmosphere and a heat treatment (described as B step in Table 1) by carrying the PET base while bringing the PET base into contact with the heating roller, and a film which was subjected to the A step and/or B step according to the present invention were obtained. The heat shrinkage and flatness of the film in the MD direction and the TD direction were investigated. The tension of the film in the A step was 48 N/m, and the atmosphere temperature was 180° C. The tension of the film in the B step was 143 N/m, and the temperature of the heating roller was 145° C.

### <Measuring Method>

The following measurement was conducted, and the results were shown in Table 1.

Heat shrinkage: based on JIS C-2318.
(1) Sample Bar: Five sheets was taken from a sample bar with a width of 20 mm and a length of 200 mm so as to average the whole width from the longitudinal direction and the transverse direction, and reference points were marked at a distance of 100 mm at each of central parts.
(2) Operation: After placing the sheets in a constant-temperature box held at a temperature of 150±3° C. and heating the sheets for 15 minutes, the sheets were taken out, and were left at a room temperature for 30 minutes. The distance between the reference points was then measured, and the average value was calculated by the following formula.

Heat Shrinkage(%)=(L1−L2)/L1×100

L1: Distance (mm) between Reference Points before Heating
L2: Distance (mm) between Reference Points after Heating

A sheet having heat shrinkage of more than 0.8 in the MD direction was evaluated as poor. A sheet having heat shrinkage of more than 0.6 and 0.8 or less was evaluated as average. A sheet having heat shrinkage of more than 0.4 and 0.6 or less or less was evaluated as good. A sheet having heat shrinkage of 0.4 or less was evaluated as very good.

Flatness: A base was put on a level stand and the number of uneven parts was counted in 30 m in the MD direction at the whole width. A sheet of which the number of the uneven parts was more than 20 was defined as poor. A sheet of which the number of the uneven parts was 11 to 20 was defined as average. A sheet of which the number of the uneven parts was 10 or less was defined as good.

TABLE 1

| Base | | | Heat shrink- | | | |
|---|---|---|---|---|---|---|
| thickness | Heat treatment step | | age (%) | | | |
| (μm) | A step | B step | MD | TD | Evaluation | Flatness |
| 100 | — | — | 0.83 | −0.11 | Poor | Poor |
| | Use | — | 0.20 | −0.03 | Good | Average |
| | — | Use | 0.51 | −0.04 | Average | Good |
| | Use | Use | 0.24 | −0.03 | Very good | Good |
| 175 | — | — | 0.90 | 0.05 | Poor | Poor |
| | Use | — | 0.18 | 0.01 | Good | Average |
| | — | Use | 0.60 | 0.02 | Average | Good |
| | Use | Use | 0.20 | 0.00 | Very good | Good |

The above description showed that the film which was subjected to the A step and/or B step according to the present invention had good heat shrinkage and flatness as compared with the film which was not subjected to the A step and the B step. Herein, it is believed that the low heat shrinkage in the TD direction of the sheet in which the present invention was not conducted is based on the production at the relaxing rate of 10% in the transverse stretching step.

### [Light Diffusion Sheet]

When an optical diffusion layer was formed on the optical sheet of the present invention according to Example 1 of Japanese Patent Application Laid-Open No. 2001-324609 to form an optical diffusion sheet, the adhesiveness between the laminated sheet and the optical diffusion layer is practically satisfactory, and a light diffusion sheet excellent in optical characteristics was obtained.

### [Prism Sheet]

A photocurable resin composition described in Example 1 of Japanese Patent Application Laid-Open No. 2001-114831 was coated on the optical sheet of the present invention so that the thickness was set to 25 μm by a bar coat method. A prototype with minute prism-like pattern (prism angle: 90 degrees, prism pitch: 50 μm, produced in house) was placed and was left in an oven of 80° C. for 3 minutes.

Then, a metal halide lamp was used as a light source from the side of the coating layer, and ultraviolet rays of 1.0 J/cm² were irradiated by using an UV irradiation equipment having an irradiation intensity of 250 mW/cm². When the prototype with minute prism-like pattern was separated to produce a prism sheet, the adhesiveness between the laminated sheet and the prism layer is practically satisfactory, and the prism sheet excellent in optical characteristics was obtained.

### [Hard Coat Sheet]

“Activity energy line cured layer (hard coat layer) coating liquid” described in Example of Japanese Patent Application Laid-Open No. 2001-323087 was coated on the optical film of the present invention by the bar coat method so that the drying film thickness was set to 8 μm, and the coating liquid was cured by ultraviolet-ray irradiation, thereby forming a hard coat layer. The hard coat sheet thus obtained had good adhesiveness between the laminated sheet and the hard coat layer, and was excellent in optical characteristics.

### [Antireflective Sheet]

A hard coat layer, silver colloid layer and antireflective layer described in Example 1 of Japanese Patent Application Laid-Open No. 2002-98803 were laminated in this order on the optical sheet of the present invention to produce an antireflective sheet. The hard coat layer, the silver colloid layer and the antireflective layer were respectively coated so that the coated thickness of the hard coat layer, the coated amount of the silver colloid layer and the coated thickness of the antireflective layer were respectively set to 12 μm, 70 mg/m² and 85 nm. The antireflective sheet thus obtained had good adhesiveness between the laminated sheet and the hard coat layer, and was excellent in optical characteristics.

1. A method for producing an optical film comprising the steps of:
conducting a heat treatment by carrying a biaxially stretched film of a thermoplastic resin prepared by biaxial stretching in a heated atmosphere, and/or
conducting a heat treatment by carrying the biaxially stretched film while bringing the biaxially stretched film into contact with a heating roller.

2. The method for producing the optical film according to claim 1, wherein
the heat treatment is conducted in a state where a coating layer is formed on the biaxially stretched film.

3. The method for producing the optical film according to claim 2, wherein
the heat treatment by carrying the biaxially stretched film in the heated atmosphere also functions as a drying step for the coating layer.

4. The method for producing the optical film according to claim 1, wherein
the heat treatment is conducted after 3 to 20% heat relaxation of the biaxially stretched film is conducted in a transverse direction.

5. The method for producing the optical film according to claim 1, wherein
the biaxially stretched film carried in the heated atmosphere has a tension of 30 to 150 N/m and the atmosphere has a temperature of 130 to 180° C.

6. The method for producing the optical film according to claim 1, wherein
the biaxially stretched film carried while being brought into contact with the heating roller has a tension of 80 to 450 N/m and the roller has a temperature of 145 to 160° C.

7. The method for producing the optical film according to claim 1, wherein
the biaxially stretched film after the heat treatment has heat shrinkage of 0.5% or less in a machine direction (MD direction) and heat shrinkage of 0.1% or less in a transverse direction (TD direction).

8. An optical film prepared by the method for producing the optical film according to claim 1.

9. The optical film according to claim 8, wherein the thermoplastic resin is a polyester resin.

10. A light diffusion sheet comprising the optical film according to claim 8.

11. An electromagnetic wave shielding sheet comprising the optical film according to claim 8.

12. An infrared ray shielding sheet comprising the optical film according to claim 8.

13. An UV shielding sheet comprising the optical film according to claim 8.

14. A hard coat sheet comprising the optical film according to claim 8.

15. An anti-glare sheet comprising the optical film according to claim 8.

16. A prism sheet comprising the optical film according to claim 8.

17. An antireflective sheet comprising the optical film claim 8.
